(19) United States
(12) Patent Application Publication
(10) Pub. No.: US 2016/0162209 A1
(43) Pub. Date: Jun. 9, 2016

(54) DATA STORAGE CONTROLLER

(71) Applicant: HYBRID LOGIC LTD, Bristol (GB)

(72) Inventors: Jean Paul CALDERONE, Dover-Foxcroft, ME (US); Itamar TURNER-TRAURING, Cambridge, MA (US)

(21) Appl. No.: 14/562,248

(22) Filed: Dec. 5, 2014

(51) Int. Cl. G06F 3/06

(52) U.S. Cl. CPC G06F 3/0619; G06F 3/0689; G06F 3/0665

(57) ABSTRACT

A data storage controller for controlling data storage in a storage environment comprising at least one of: a backend storage system of a first type in which data volumes are stored on storage devices physically associated with respective machines; and a backend storage system of a second type in which data volumes are stored on storage devices virtually associated with respective machines, the controller comprising: a configuration data store including configuration data which defines for each data volume at least one primary mount, wherein a primary mount is a machine with which the data volume is associated; a volume manager connected to access the configuration data store and having a command interface configured to receive commands to act on a data volume; and a plurality of convergence agents, each associated with a backend storage system and operable to implement a command received from the volume manager by executing steps to control its backend storage system, wherein the volume manager is configured to receive a command which defines an operation on the data volume which is agnostic of, and does not vary with, the backend storage system type in which the data volume to be acted on is stored, and to direct a command instruction to a convergence agent based on the configuration data for the data volume, wherein the convergence agent is operable to act on the command instruction to execute the operation in its back end storage system.

### FIELD

The present invention relates to a data storage controller and to a method of controlling data volumes in a data storage system.

### BACKGROUND

There are many scenarios in computer systems where it becomes necessary to move a volume of data (a data chunk) from one place to another place. One particular such scenario arises in server clusters, where multiple servers arranged in a cluster are responsible for delivering applications to clients. An application may be hosted by a particular server in the cluster and then for one reason or another may need to be moved to another server. An application which is being executed depends on a data set to support that application. This data set is stored in a backend storage system associated with the server. When an application is moved from one server to another, it may become necessary to move the data volume so that the new server can readily access the data.

For example, a file system local to each server can comprise a number of suitable storage devices, such as disks. Some file systems have the ability to maintain point in time snapshots and provide a mechanisms to replicate the difference between two snapshots from one machine to another. This is useful when a change in the location of a data volume is required when an application migrates from one server to another. One example of a file system which satisfies these requirements is the Open Source ZFS file system.

Different types of backend storage system are available, in particular backend storage system in which data volumes are stored on storage devices virtually associated with respective machines, rather than physically in the case of the ZFS file system.

At present, there is a constraint on server clusters in that any particular cluster of server can only operate effectively with backend storage of the same type. This is because the mechanism and requirements for moving data volumes between the storage devices within a storage system (or virtually) depends on the storage type.

Moreover, the cluster has to be configured for a particular storage type based on a knowledge of the implementation details for moving data volumes in that type.

### SUMMARY OF THE INVENTION

According to one aspect of the invention, there is provided a data storage controller for controlling data storage in a storage environment comprising: a backend storage system of a first type in which data volumes are stored on storage devices physically associated with respective machines; and a backend storage system of a second type in which data volumes are stored on storage devices virtually associated with respective machines, the controller comprising: a configuration data store including configuration data which defines for each data volume at least one primary mount, wherein a primary mount is a machine with which the data volume is associated; a volume manager connected to access the configuration data store and having a command interface configured to receive commands to act on a data volume; and a plurality of convergence agents, each associated with a backend storage system and operable to implement a command received from the volume manager by executing steps to control its backend storage system, wherein the volume manager is configured to receive a command which defines an operation on the data volume which is agnostic of, and does not vary with, the backend storage system type in which the data volume to be acted on is stored, and to direct the command to a convergence agent based on the configuration data for the data volume, wherein the configuration agent is operable to act on the command to execute the operation in its back end storage system.

Another aspect of the invention provides a method of controlling data storage in a storage environment comprising a backend storage system of a first type in which data volumes are stored on storage devices physically associated with respective machines; and a backend storage system of a second type in which data volumes are stored on storage devices virtually associated with respective machines, the method comprising: providing configuration data which defines for each data volume at least one primary mount, wherein a primary mount is a machine with which the data volume is associated; generating a command to a volume manager connected to access the configuration data, wherein the command defines an operation on the data volume which is agnostic and does not vary with the backend storage system type in which the data volume to be acted on is stored; implementing the command in a convergence agent based on the configuration data for the data volume, wherein the convergence agent acts on the command to execute the operation in its backend storage system based on the configuration data.

Thus, the generation and recognition of commands concerning data volumes is separately semantically from the implementation of those commands. This allows a system to be built which can be configured to take into account different types of backend storage and to allow different types of backend storage to be added in. Convergence agents are designed to manage the specific implementation details of a particular type of backend storage, and to recognise generic commands coming from a volume manager in order to carry out those implementation details.

In preferred embodiments, a leasing/polling system allows the backend storage to be managed in the most effective manner for that storage system type as described more fully in the following.

For a better understanding of the invention and to show how the same may be carried into effect, reference will now be made by way of example, to the accompanying drawings in which:

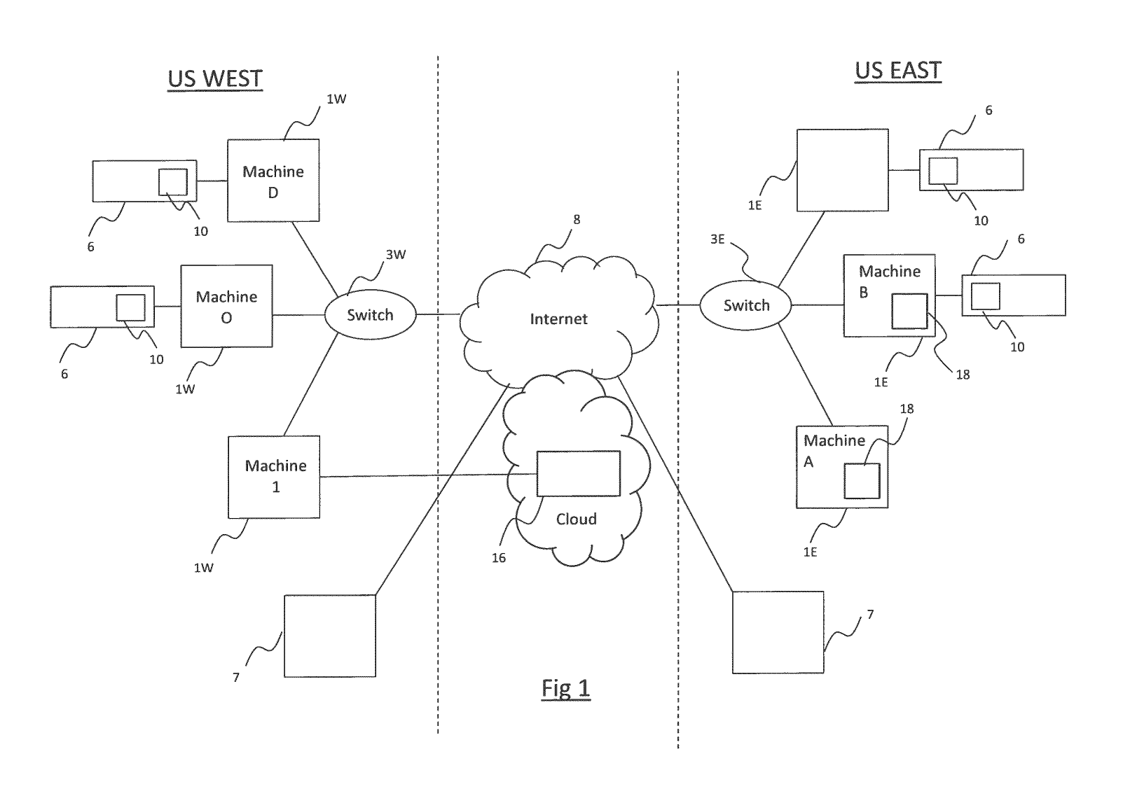

FIG. 1 is a schematic diagram of a server cluster;

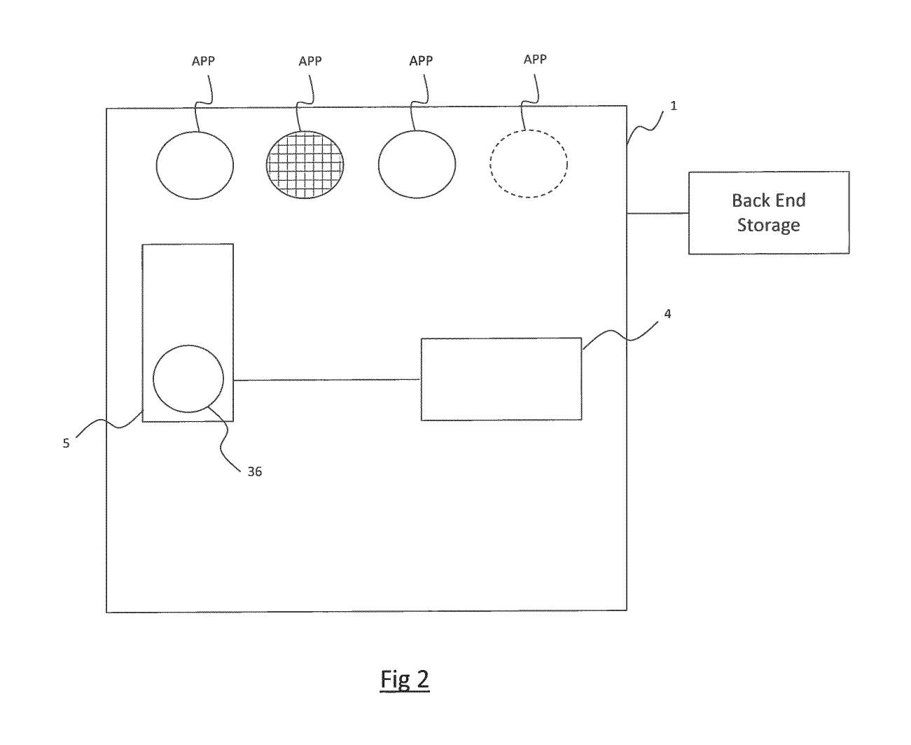

FIG. 2 is a schematic block diagram of a server;

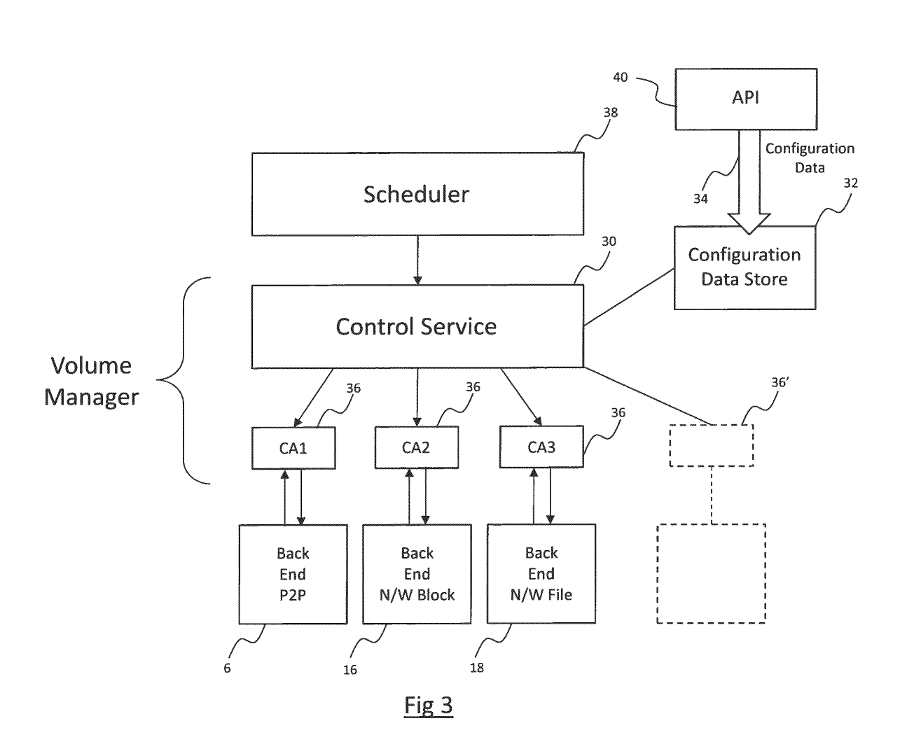

FIG. 3 is a schematic architecture diagram of a data storage control system;

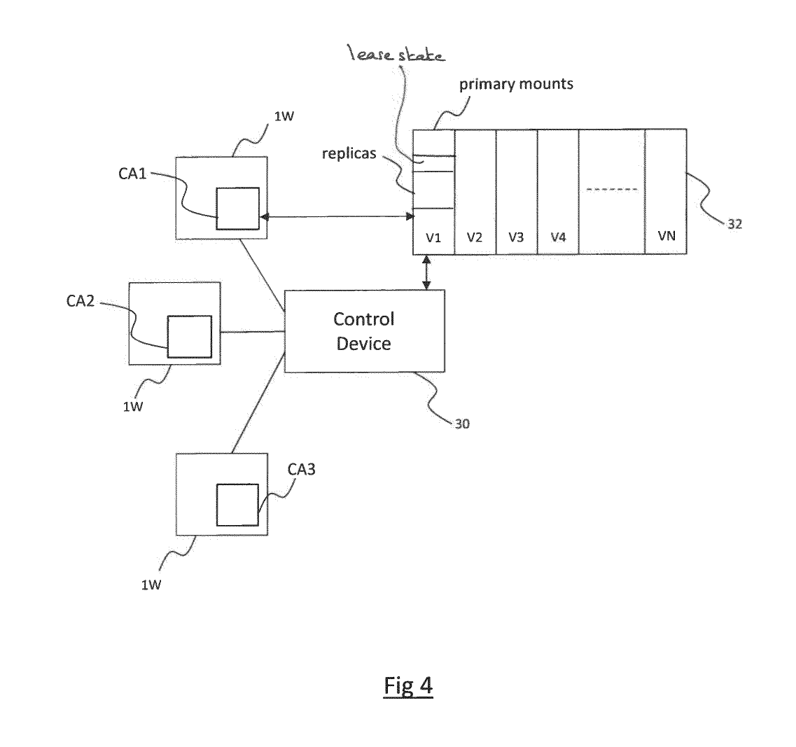

FIG. 4 is s schematic block diagram showing deployment state data; and

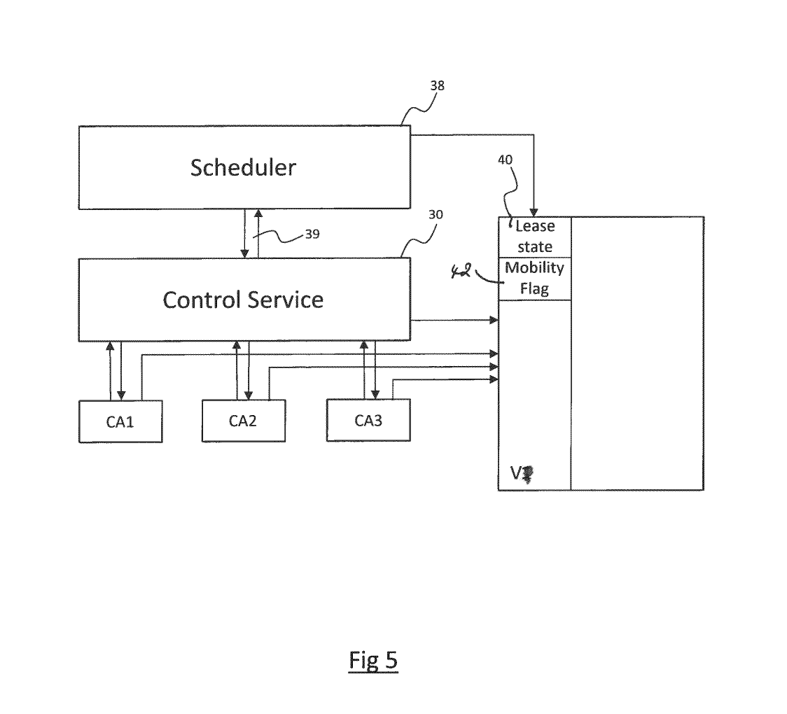

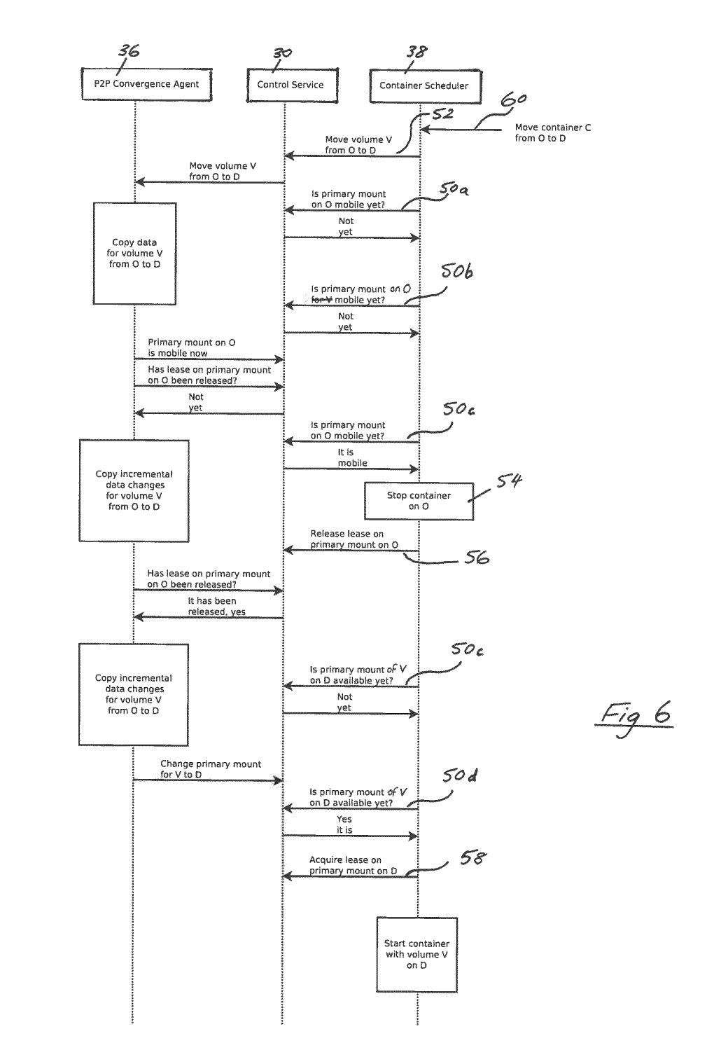

FIGS. 5 and 6 are diagrams illustrating the operation of the data storage control system.

FIG. 1 illustrates a schematic architecture of a computer system in which the various aspects of the present invention discussed herein can usefully be implemented. It will readily be appreciated that this is only one example, and that many variations of server clusters may be envisaged (including a cluster of 1).

FIG. 1 illustrates a set of servers 1 which operate as a cluster. The cluster is formed in 2 subsets, a first set wherein the servers are labelled 1E and a second set wherein the servers are labelled 1W. The subsets may be geographically separated, for example the servers 1E could be on the East Coast of the US, while the servers labelled 1W could be on the West Coast of the US. The servers 1E of the subset E are connected by a switch 3E. The switch can be implemented in any form—all that is required is a mechanism by means of which each server in that subset can communicate with another server in that subset. The switch can be an actual physical switch with ports connected to the servers, or more probably could be a local area network or Intranet. The servers 1W of the western subset are similarly connected by a switch 3W. The switches 3E and 3W are themselves interconnected via a network, which could be any suitable network for spanning a geographic distance. The Internet is one possibility. The network is designated 8 in FIG. 1.

Each server is associated with a local storage facility 6 which can constitute any suitable storage, for example discs or other forms of memory. The storage facility 6 supports a database or an application running on the server 1 which is for example delivering a service to one or more client terminal 7 via the Internet. Embodiments of the invention are particularly advantageous in the field of delivering web-based applications over the Internet.

In FIG. 1 one type of storage facility 6 supports a file system 10. However, other types of storage facility are available, and different servers can be associated with different types in the server cluster architecture. For example, server 1W could be associated with a network block device 16 (shown in a cloud connected via the Internet), and server 1E could be associated with a peer-to-peer storage system 18 (shown diagrammatically as the respective hard drives of two machines). Each server could be associated with more than one type of storage system. The storage systems are referred to herein as “storage backends”. In the server clusters illustrated in FIG. 1, the storage backends support applications which are running on the servers. The storage backend local to each server can support many datasets, each dataset being associated with an application. The server cluster can also be used to support a database, in which case each storage backend will have one or more dataset corresponding to a database.

The applications can be run directly or they can be run inside containers. When run inside containers, the containers can mount parts of the host server's dataset. Herein an application specific chunk of data is referred to as a “volume”. Herein, the term “application” is utilised to explain operation of the various aspects of the invention, but is understood that these aspect apply equally when the server cluster is supporting a database.

Each host server (that is a server capable of hosting an application or database) is embodied as a physical machine. Each machine can support one or more virtual application. Application may be moved between servers in the cluster, and as a consequence of this, it may be necessary to move data volumes so that they are available to the new server hosting the application or database. A data volume is referred to as being “mounted on” a server (or machine) when it is associated with that machine and accessible to the application(s) running on it. A mount (sometimes referred to as a manifestation) is an association between the data volume and a particular machine. A primary mount is a read-unit and guaranteed to be up to date. Any others are read only.

For example, the system might start with a requirement that:

“Machine 1 runs a PostgreSQL server inside a container, storing its data on a local volume”, and later on the circumstances will alter such that the new requirement is:

“to run PostgreSQL server on machine 2”.

In the later state, it is necessary to ensure that the volume originally available on machine 1 will now be available on machine 2. These machines can correspond for example, to the server's 1W/1E in FIG. 1. For the sake of completeness, the structure of a server is briefly noted and illustrated in FIG. 2.

FIG. 2 is a schematic diagram of a single server 1. The server comprises a processor 5 suitable for executing instructions to delivery different functions as discussed more clearly herein. In addition the server comprises memory 4 for supporting operation of the processor. This memory is distinct from the storage facility 6 supporting the datasets. A server 1 can be supporting multiple applications at any given time. These are shown in diagrammatic form by the circles labelled app. The app which is shown crosshatched designates an application which has been newly mounted on the server 1. The app shown in a dotted line illustrates an application which has just been migrated away from the server 1.

In addition the server supporting one or more convergence agent 36 to be described later, implemented by the processor 5.

As already mentioned, there are variety of different distributed storage backend types. Each backend type has a different mechanism for moving data volumes. A system in charge of creating and moving data volumes is a volume manager. Volume managers are implemented differently depending on the backend storage type:

### 1. Peer-to-Peer Backend Storage.

Data is stored initially locally on one of machine A's hard drives, and when it is moved it is copied over to machine B's hard drive. Thus, a Peer-to-Peer backend storage system comprises hard drives of machines.

### 2. Network Block Device

Cloud services like Amazon Web Service AWS provide on demand virtual machines and offer block devices that can be accessed over a network (e.g. AWS has Elastic Block Store EBS). These reside on the network and are mounted locally on the virtual machines within the cloud as a block device. They emulate a physical hard drive. To accomplish the command:

“Machine 1 will run a PostgreSQL server inside a container, storing its data on a local volume”

such a block device is attached on machine 1, formatted as a file system and the data from the application or database is written there. To accomplish the “move” command such that the volume will now be available on machine 2, the block device is detached from machine 1 and reattached to machine 2. Since the data was anyway always on some remote server (in the cloud) accessible via the network, no copying of the data is necessary. SAN setups would work similarly.

### 3. Network File System

Rather than a network available block device, there may be a network file system. For example, there may be a file server which exports its local file system via NFS or SMB network file systems. Initially, this remote file system is mounted on machine O. To “move” the data volumes, the file system is unmounted and then mounted on machine D. No copying is necessary.

### 4. Local Storage

Local Storage on a Single Node only is also a backend storage type which may need to be supported.

One example of a Peer-to-Peer backend storage system is the Open Source ZFS file system. This provides point in time snapshots, each named with a locally unique string, and a mechanism to replicate the difference between two snapshots from one machine to another.

From the above description, it is evident that the mechanism by which data volumes are moved depends on the backend storage system which is implemented. Furthermore, read-only access to data on other machines might be available (although possibly out of date). In the Peer-to-Peer system this would be done by copying data every once in a while from the main machine that is writing to the other machines. In the network file system set up, the remote file system can be mounted on another machine, although without write access to avoid corrupting the database files. In the block device scenario this access is not possible without introducing some reliance on the other two mechanisms (copying or a network file system).

There are other semantic differences. In the case of the Peer-to-Peer system, the volume only really exists given a specific instantiation on a machine. In the other two systems, the volume and its data may exist even if they are not accessible on any machine.

A summary of the semantic differences between these backend storage types is given below.

### Semantic Differences

### ZFS

A “volume”, e.g. the files for a PostgreSQL database, is always present on some specific node.
One node can write to its copy.
Other nodes may have read-only copies, which typically will be slightly out of date.
Replication can occur between arbitrary nodes, even if they are in different data centres.

### EBS or Other IaaS Block Storage

A “volume” may not be present on any node, if the block device is not attached anywhere.
A “volume” can only be present on a single node, and writeable. (While technically it could be read-only that is not required).
Attach/detach (i.e. portability) can only happen within a single data centre or region. Snapshots can typically be taken and this can be used to move data between regions.

### NFS

A “volume” may not be present on any node, if the file system is not mounted anywhere.
A “volume” can be writeable from multiple nodes.

### Single Node Local Storage

A “volume”, e.g. the files for a PostgreSQL database, is always present and writeable on the node.

### Summary

| | Existence | | |
|---|---|---|---|
| | outside of | Writing nodes for | Reading nodes for |
| | nodes | existing volume | existing volume |
| ZFS | No | 0 or 1 (0 only | 0 to N (lagging) |
| | | possible if read-only | |
| | | copy exists and a | |
| | | writer node is offline) | |
| EBS | Yes | 0 or 1 | 0 (technically 1 but |
| | | | this is more of a |
| | | | configuration choice |
| | | | than an actual |
| | | | restriction) |
| NFS | Yes | 0 to N | 0 (technically N but |
| | | | this more of a |
| | | | configuration choice |
| | | | than an actual |
| | | | restriction) |
| Single Node | No | 1 | 0 |
| Local | | | |
| Storage | | | |

In the scenario outlined above, the problem that manifests itself is how to provide a mechanism that allows high level commands to be implemented without the requirement of the command issuer understanding the mechanism by which the command itself will be implemented. Commands include for example:

“Move data” [as discussed above]
“Make data available here”
“Add read-only access here”
“Create volume”
“Delete volume”, etc.

This list of commands is not all encompassing and a person skilled in the art will readily understand the nature of commands which are to be implemented in a volume manager.

FIG. 3 is a schematic block diagram of a system architecture for providing the solution to this problem. The system provides a control service 30 which is implemented in the form of program code executed by a processor and which has access to configuration data which is stored in any storage mechanism accessible to control service. Configuration data is supplied by users in correspondence to the backend storage which they wish to manage. This can be done by using an API 40 to change a configuration or by providing a completely new configuration. This is shown diagrammatically by input arrow 34 to the configuration data store 32.

The control service 30 understands the configuration data but does not need to understand the implementation details of the backend storage type. At most, it knows that certain backends have certain restrictions on the allowed configuration.

The architecture comprises convergence agents 36 which are processes which request the configuration from the control service and then ensure that the actual system state matches the desired configuration. The convergence agents are implemented as code sequences executed by a processor. The convergence agents are the entities which are able to translate a generic model operating at the control service level 30 into specific instructions to control different backend storage types. Each convergence agent is shown associated with a different backend storage type. The convergence agents understand how to do backend specific actions and how to query the state of a particular backend. For example, if a volume was on machine O and is now supposed to be on machine D, a Peer-to-Peer convergence agent will instruct copying of the data, but an EBS agent will instruct attachment and detachment of cloud block devices. Because of the separation between the abstract model operating in the control service 30 and the specific implementation actions taken by the convergence agents, it is simple to add new backends by implementing new convergence agents. This is shown for example by the dotted lines in FIG. 3, where the new convergence agent is shown as 36′. For example, to support a different cloud-based block device or a new Peer-to-Peer implementation, a new convergence agent can be implemented but the external configuration and the control service do not need to change.

The abstract configuration model operated at the control service 30 has the following properties.

A “volume” is a cluster wide object that stores a specific set of data. Depending on the backend storage type, it may exist even if no nodes have access to it. A node in this context is a server (or machine).

Volumes can manifest on specific nodes.

A manifestation may be authoritative, meaning it has the latest version of the data and can be written to. This is termed a “primary mount”.

Otherwise, the manifestation is non-authoritative and cannot be written to. This is termed a “replica”.

A primary mount may be configured as read-only, but this is a configuration concern, not a fundamental implementation restriction.

If a volume exists, it can have the following manifestations depending on the backend storage type being used, given N servers in the cluster:

| | Primary mounts | Replicas |
|---|---|---|
| Peer-to-peer | 1, or 0 due to machine failure in | 0 to N |
| | which case a recovery process is | |
| | required | |
| EBS | 0 or 1 | 0 |
| NFS | 0 to N | 0 to N |

Given the model above, the cluster is configured to have a set of named volumes. Each named volume can be configured with a set of primary mounts and a set of replicas. Depending on the backend storage type, specific restrictions may be placed on a volume's configuration, for example, when using EBS no replicas are supported and no more than one primary mount is allowed.

FIG. 4 illustrates in schematic terms the setup of a cluster of servers (in this case the servers 1W as in FIG. 1), but instead of each server having its own associated backend storage to deal with directly as shown in FIG. 1, the servers communicate with the control service 30 which itself operates in accordance with the set of named volumes V1 . . . Vn. Each volume has configuration data associated with it which configures the volume with a set of primary mounts and a set of replicas.

The architecture of FIG. 3 provides a generic configuration model and an architectural separation between generic configurations in particular backend implementations. This allows users of the system to request high level operations by commands for example “move this volume” without exposing the details of the backend implementation. It also allows expanding the available backends without changing the rest of the system.

The architecture shown in FIG. 3 can be utilised in a method for minimising application downtime by coordinating the movement of data and processes within machines on a cluster with support for multiple backends. This is accomplished utilising a scheduler layer 38. For example, consider a situation where a process on machine O that needs some data provided by a distributed storage backend needs to be moved to machine D. In order to minimise downtime, some coordination is necessary between moving the data and shutting down and starting the processes.

Embodiments of the present invention provide a way to do this which works with various distributed storage backend types, such that the system that is in charge of the processes does not need to care about the implementation details of the system that is in charge of the data. The concept builds on the volume manager described above which is in charge of creating and moving volumes. The schedule layer 38 provides a container scheduling system that decides which container runs on which machine in the cluster. In principle, the scheduler and the volume manager operate independently. However, there needs to be coordination. For example, if a container is being executed on machine O with a volume it uses to store data, and then the scheduler decides to move the container to machine D, it needs to tell the volume manager to also move the volume to machine D. In principle, a three-step process driven by the scheduler would accomplish this:
1. Scheduler stops the container on machine O
2. Scheduler tells the volume manager to move the volume from machine O to machine D and waits until that finishes
3. Scheduler starts container on machine D.

A difficulty with this scenario is that it can lead to significant downtime for the application. In the case where the backend storage type is Peer-to-Peer, all of the data may need to be copied from machine O to machine D in the second step. In the case where the backend storage type is network block device, the three-step process may be slow if machine O and machine D are in different data centres, for example, in AWS EBS a snapshot will need to be taken and moved to another data centre.

As already mentioned in the case of the ZFS system, one way of solving this is to use incremental copying of data which would lead for example to the following series of steps:
1. The volume manager makes an initial copy of data in the volume from machine O to machine D. The volume remains on machine O.
2. The scheduler stops a container on machine O.
3. The volume manager does incremental copy of changes that occur to the data since step 1 was started, from machine O to machine D. This is much faster since much less data would be copied. The volume now resides on machine 2.
4. Scheduler starts container on machine D.

The problem associated with this approach is that it puts a much more significant requirement for coordination between the scheduler and the volume manager. Different backends have different coordination requirements. Peer-to-Peer backends as well as crossdata centre block device backends require a four-step solution to move volumes, while a single datacentre block device as well as network file system backends only need the three-step solution. It is an aim of embodiments of the present invention to support multiple different scheduler implementations, and also to allow adoption of the advantageous volume manager architecture already described.

In order to fit into the framework described with respect to FIG. 3, the volume configuration should be changed only once, when the operation is initiated.

The solution to this problem is set out below. Reference is made herewith to FIGS. 5 and 6. Moving volumes uses deployment state which is derived from a wide range of heterogeneous sources.

For example, one kind of deployment state is whether or not an application A is running on machine M. This true/false value is implicitly represented by whether a particular program (which has somehow been defined as the concrete software manifestation of application A is running on the operating system of machine M).

Another example is whether a replica of a data volume V exists on machine M. The exact meaning of this condition varies depending on the specific storage system in use. When using the ZFS P2P storage system, the condition is true if a particular ZFS dataset exists on a ZFS storage pool on machine M.

In all of these cases, when a part of the system needs to learn the current deployment state, it will interrogate the control service. To produce the answer, the control service will interrogate each machine and collate and return the results. To produce an answer for the control service, each machine will inspect the various heterogeneous sources of the information and collate and return those results.

Put another way, the deployment state mostly does not exist in any discrete storage system but is widely spread across the entire cluster.

The only exception to this is the lease state which is kept together with the configuration data in the discrete configuration store mentioned above.

The desired volume configuration is changed once, when the operation is initiated. When a desired change of container location is communicated to the container scheduler (message 60) it changes the volume manager configuration appropriately. After that all interactions between scheduler and volume manager are based on changes to the current deployment state via leases, a mobility attribute and polling/notifications of changes to the current deployment state:

Leases on primary mounts are part of the current deployment state, but can be controlled by the scheduler: a lease prevents a primary mount from being removed. When the scheduler mounts a volume's primary mount into a container it should first lease it from the volume manager, and release the lease when the container stops. This will ensure the primary mount isn't moved while the container is using it. This is shown in the lease state 40 in the primary mount associated with volume V1. For example, the lease state can be implemented as a flag—for a particular data volume, either the lease is held or not held.

Leases are on the actual state, not the configuration. If the configuration says “volume V should be on machine D” but the primary mount is still on machine O, a lease can only be acquired on the primary mount on machine O since that is where it actually is.

A primary mount's state has a mobility flag 42 that can indicate “ready to move to X”. Again, this is not part of the desired configuration, but rather part of the description of the actual state of the system. This flag is set by the volume manager (control service 30).

Notifications let the scheduler know when certain conditions have been met, allowing it to proceed with the knowledge that volumes have been setup appropriately. This may be simulated via polling, i.e. the scheduler continuously asks for the state of the lease and mobility flag 8, see poll messages 50 in FIG. 6.

When the scheduler first attaches a volume V to a container, say on machine Origin, it acquires a lease 40. We want to move to node Destination. The scheduler will:
1. Tell the volume manager to move the volume V from Origin to Destination, 52.
2. Poll current state of primary mount on Origin until its mobility flag indicates it is ready to move to Destination (50a . . . 50c). The repeated poll messages are important because it is not possible to know a priori when the response will be “yes” instead of “not yet”. Note that V can have only one primary mount, which current state indicates is O. O could be the primary mount for other volumes which are not being moved.
   On EBS this will happen immediately, at least for moves within a datacentre, and likewise for network file systems.
   On peer-to-peer backends this will happen once an up-to-date copy of the data has been pushed to Destination.
3. Stop the container on Origin 54, and releases the lease 56 on primary mount on Origin.
4. Poll current deployment state until primary mount appears on Destination (50c, 50d).
5. Acquire lease 58 on primary mount on Destination and then start container on Destination.

The interface 39 between the scheduler 38 and the volume manager 30 is therefore quite narrow:
1. “Move this volume from X to Y”
2. “Get system state”, i.e. which primary mounts are on which machines, and for each primary mount whether or not it has a mobility flag.
3. “Acquire lease”
4. “Release lease”

There follows a description of how two different volume manager backends might handle this interaction.

First, in the peer-to-peer backend:
1. Convergence agent queries control service and notices that the volume needs to move from Origin to Destination, so starts copying data from Origin to Destination.
2. Since there is a lease on the primary mount on Origin, it continues to be the primary mount for the volume.
3. Eventually copying finishes, and the two copies are mostly in sync, so convergence agent sets the mobility flag to true on the primary mount.
4. Convergence agent notices (for the volume that needs to move) that the lease was released, allowing it to proceed to the next stage of the data volume move operation so tells control service that copy on Origin no longer the primary mount and therefore prevent further writes.
5. Convergence agent copies incremental changes from Origin to Destination.
6. Convergence agent tells control service that Destination's copy is now the primary mount.

Second, in EBS backend within a single datacentre:
1. Convergence agent queries control service and notices that the volume needs to move from Origin to Destination, so it immediately tells control service to set the mobility flag to true on the primary mount.
2. Convergence agent notices that the lease was released, allowing it to proceed to the next stage of the data volume move operation so tells control service that Origin no longer the primary mount and therefore prevent further writes.
3. Convergence agent detaches block device from Origin and attaches it to destination.
4. Convergence agent tells control service that Destination's now has the primary mount.

Notice that no details of how data is moved is leaked: the scheduler has no idea how the volume manager moves the data and whether it's a full copy followed by incremental copy, a quick attach/detach or any other mechanism. The volume manager in turn doesn't need to know anything about containers or how they are scheduled. All it knows is that sometimes volumes are moved, and that it can't move a volume if the relevant primary mount has a lease.

Embodiments of the invention described herein provide the following features.
1. High-level concurrency constraints. For example unnecessary snapshots should be deleted, but a snapshot that is being used in a push should not be deleted.
2. Security. Taking over a node should not means the whole cluster's data is corrupted; node B's data cannot be destroyed by node A, and it should be possible to reason about what can be trusted or not once the problem is detected, and the ability to quarantine the corrupted node.
3. Node-level consistency. High-level operations (e.g. ownership change) may involve multiple ZFS operations. It is desirable that the high-level operation to finish even if the process crashes half-way through.
4. Cluster-level atomicity. Changing ownership of a volume is a cluster-wide operation, and needs to happen on all nodes.
5. API robustness. The API's behaviour is clear, with easy ability to handle errors and unknown success results.
6. Integration with orchestration framework: i.e. the volume manager.
   a. if a volume is mounted by an application (whether in a container or not) it should not be deleted
   b. Two-phase push involves coordinating information with an orchestration system.

These features are explained in more detail below.

The volume manager is a cluster volume manager, not an isolated per-node system. A shared, consistent data storage system 32 stores:
1. The desired configuration of the system.
2. The current known configuration of each node.
3. A task queue for each node. Ordering may be somewhat more complex than a simple linear queue. For example it may be a dependency graph, where task X must follow task Y but Z isn't dependent on anything. That means Y and Z can run in parallel.

Where the configuration is set by an external API, the API supports:
1. Modifying the desired configuration.
2. Retrieving current actual configuration.
3. Retrieving desired configuration.
4. Possibly notification when (parts of) the desired configuration have been achieved (alternatively this can be done “manually” with polling).

The convergence agents:
1. Read the desired configuration, compare to local configuration and insert or remove appropriate tasks into the task queue.
2. Run tasks in task queue.
3. Update the known configuration in shared database.
4. Only communicate with other nodes to do pushes (or perhaps pulls).

### Basic Local Node Algorithm

Note that each convergence agent has its own independent queue.

Convergence loop: (this defines the operation of a convergence agent)
1. Retrieve desired configuration for cluster.
2. Discover current configuration of node.
3. Update current configuration for node in shared database.
4. Calculate series of low-level operations that will move current state to desired state.
5. Enqueue any calculated operations that are not in the node's task queue in shared database.
6. Remove operations from queue that are no longer necessary.

Failures result in a task and all tasks that depend on it being removed from the queue; they will be re-added and therefore automatically retried because of the convergence loop.

### Operational Loop:

1. Read next operation from task queue.
2. Execute operation.
3. Remove operation from queue.

### Scheduled Events Loop:

1. Every N seconds, schedule appropriate events by adding tasks to the queue. E.g. clean-up of old snapshots.

### High-Level Concurrency Constraints

Given the known configuration and the task queue, it is possible at any time to know what relevant high-level operations are occurring, and to refuse actions as necessary.

Moreover given a task queue one it is possible to insert new tasks for a node ahead of currently scheduled ones.

### Security

The configuration data storage is preferably selected so that nodes can only write to their own section of task queue, and only external API users can write to desired configuration.

Nodes will only accept data from other nodes based on desired configuration.

Data will only be deleted if explicitly requested by external API, or automatically based on policy set by cluster administrator. For example, a 7-day retention policy means snapshots will only be garbage collected after they are 7 days old, which means a replicated volume can be trusted so long as the corruption of the master is noticed before 7 days are over.

### Node-Level Atomicity

The task queue will allow nodes to ensure high-level operations finish even in the face of crashes.

### Cluster-Level Consistency

A side-effect of using a shared (consistent) database.

### API Robustness

The API will support operations that include a description of both previous and desired state: “I want to change owner of volume V from node A to node B.” If in the meantime owner changed to node C the operation will fail.

Leases on volumes prevent certain operations from being done to them (but do not prevent configuration changes from being made; e.g., configuration about ownership of a volume can be changed while a lease is held on that volume. Ownership won't actually change until the lease is released). When e.g. Docker mounts a volume into a container it leases it from the volume manager, and releases the lease when the container stops. This ensures the volume isn't moved while the container is using it.

Notifications let the control service know when certain conditions have been met, allowing it to proceed with the knowledge that volumes have been setup appropriately.

### EXAMPLE SCENARIOS

In these scenarios, the scheduler 38 is referred to as an orchestration framework (OF), and the control service 30 is referred to as the volume manager (VM).

A detailed integration scenario for creating a volume for a container:
1. OF tells VM the desired configuration should include a volume V on node A.
2. OF asks for notification of existence of volume V on node A.
3. VM notifies OF that volume V exists.
4. OF asks VM for a lease on volume V.
5. OF mounts the volume into a container.

A detailed integration scenario for two-phase push, moving volume V from node A to node B (presuming previous steps).

### Setup:

1. OF tells VM it wants volume V to be owned by node B, not A.
2. OF asks for notification of volume V having a replica on node B that has delta of no more than T seconds or B megabytes from primary replica.
3. OF asks for notification of volume V being owned by node B.

### First Notification:

4. VM notifies OF that replica exists on B with sufficiently small delta.
5. OF stops container on node A.
6. OF tells VM it is releasing lease on volume V.

### Second Notification:

7. VM notifies OF that V is now owned by node B.
8. OF tells VM that it now has a lease on volume V.
9. OF starts container on node B.

### More or Less in Linear Order What Happens is:

1. VM configuration changes such that V is supposed to be on node B.
2. Node A notices this, and pushes a replica of V to B.
3. Node A then realizes it can't release ownership of because there's a lease on V, so it drops that action.
4. Steps 2 and 3 repeat until lease is released.
5. Repeat until ownership of V is released by A: Node B knows it should own V, but fails because A stills own it.
6. Node B notices that one of the notification conditions is now met—it has a replica of V that has a small enough delta. So Node B notifies the OF that the replica is available.
7. OF releases lease on V.
8. Next convergence loop on A can now continue—it releases ownership of V and updates known configuration in shared database.
9. Next convergence loop on Node B notices that V is now unowned, and so takes ownership of it.
10. Node B notices notification condition is now met—it owns V. It notifies OF.
11. OF leases V on B.

### API

The execution model of the distributed volume API is based on asserting configuration changes and, when necessary, observing the system for the events that take place when the deployment state is brought up-to-date with respect to the modified configuration.

Almost all of the APIs defined in this section are for asserting configuration changes in this way (the exception being the API for observing system events).

### Create a Volume

Change the desired configuration to include a new volume.

Optionally specify a UUID for the new volume.

Optionally specify a node where the volume should exist.

Optionally specify a non-unique user-facing name?

Receive a success response (including UUID) if the configuration change is accepted (not necessarily prior to the existence of the volume)

Receive an error response if some problem prevents the configuration change from being accepted (for example, because of lack of consensus).

### Destroy a Volume

Change desired configuration to exclude a certain volume.

Specify the UUID of the no-longer desired volume.

Receive a success response if the configuration change is accepted

(volume is not actually destroyed until admin-specified policy dictates; for example, not until seven days have passed).

Receive an error response if some problem prevents the configuration change from being accepted (for example, because of lack of consensus, because there is no such volume)

### Change the Owner of a Volume

Change the desired configuration of which node is allowed write access to a volume (bringing that node's version of the volume up to date with the owner's version first if necessary).

Specify the UUID of the volume.

Specify the node which will become the owner.

Optionally specify a timeout—if the volume cannot be brought up to date before the timeout expires, give up

Receive a success response if the configuration change is accepted.

Receive an error response if not (lack of consensus, invalid UUID, invalid node identifier, predictable disk space problems)

### Have a Replica of a Volume on a Particular Node at Least as Up to Date as X

Create a replication relationship for a certain volume between the volume's owner and another node.

Specify the UUID of the volume.

Specify the node which should have the replica.

Specify the desired degree of up-to-dateness, e.g. “within 600 seconds of owner version” (or not? just make it as up to date as possible. maybe this is an add on feature later)

### Observe a Volume for Changes

Open an event stream describing all changes made to a certain volume.

Specify the UUID of the volume to observe.

Specify an event type to restrict the stream to (maybe? can always do client-side filtering)

Receive a response including a unique event stream identifier (URI) at which events can be retrieved and an idle lifetime after which the event stream identifier will expire if unused.

Receive an error response if the information is unavailable (no such volume, lack of consensus?)

### Retrieve Volume Events

Fetch buffered events describing changes made to a certain volume.

Issue request to previously retrieved URI.

Receive a success response with all events since the last request

(events like: volume created, volume destroyed, volume owner changed, volume owner change timed out? replica of volume on node X updated to time Y, lease granted, lease released)

Receive an error response (e.g. lack of consensus, invalid URI)

### Enumerate Volumes

Retrieve UUIDs of all volumes that exist on the entire cluster, e.g. with paging.

Follow-up: optionally specify node.

Receive a success response with the information if possible.

Receive an error response if the information is unavailable (lack of consensus, etc.)

### Inspect a Volume

Retrieve all information about a particular volume.

Specify the UUID of the volume to inspect.

Receive a success response with all details about the specified volume

(where it exists, which node is the owner, snapshots, etc.)

Receive an error response (lack of consensus, etc.)

### Acquire a Lease on a Volume

Mark a volume as in-use by an external system (for example, mounted in a running container) and inhibit certain other operations from taking place (but not configuration changes).

Specify the volume UUID.

Specify lease details (opaque OF-meaningful string? If OF wants to say “in use running container ABCD” and spit this out in some later human interaction, that's useful maybe. Also debugging stuff.”)

Receive a success response (including a unique lease identifier) if the configuration change is successfully made (the lease is not yet acquired! The lease-holder is on a queue to acquire the lease.)

Receive an error response for normal reasons (lack of consensus, invalid UUID, etc.)

### Release a Lease on a Volume

Mark the currently held lease as no longer in effect

(freeing the system to make deployment changes previously prevented by the lease).

Specify the unique lease id to release.

Receive a success response if the configuration change is accepted

(the lease is not release yet).

Receive an error response (lack of consensus, invalid lease id)

1. A data storage controller for controlling data storage in a storage environment comprising at least one of:
a backend storage system of a first type in which data volumes are stored on storage devices physically associated with respective machines; and
a backend storage system of a second type in which data volumes are stored on storage devices virtually associated with respective machines, the controller comprising:
a configuration data store including configuration data which defines for each data volume at least one primary mount, wherein a primary mount is a machine with which the data volume is associated;
a volume manager connected to access the configuration data store and having a command interface configured to receive commands to act on a data volume; and
a plurality of convergence agents, each associated with a backend storage system and operable to implement a command received from the volume manager by executing steps to control its backend storage system, wherein the volume manager is configured to receive a command which defines an operation on the data volume which is agnostic of, and does not vary with, the backend storage system type in which the data volume to be acted on is stored, and to direct a command instruction to a convergence agent based on the configuration data for the data volume, wherein the convergence agent is operable to act on the command instruction to execute the operation in its back end storage system.

2. A controller according to claim 1, wherein the volume manager is configured to receive commands of at least one of the following types:
create a data volume for a designated machine;
move a data volume from an origin machine to a destination machine;
delete a data volume from its primary mount.

3. A data storage controller according to claim 1, wherein the configuration data store holds configuration data which defines for at least some of the data volumes at least one machine with a replica manifestation for the data volume.

4. A data storage controller according to claim 3, wherein the machine which is the primary mount has read/write access to the data volume, and wherein the at least one machine with a replica manifestation has read only access to the data volume.

5. A data storage controller according to claim 1, which comprises a configuration data generator operable to generate configuration data to be held in the configuration data store, wherein the configuration data generator generates configuration data based on the type of backend storage system for the data volume in the configuration data store.

6. A method of controlling data storage in a storage environment comprising a backend storage system of a first type in which data volumes are stored on storage devices physically associated with respective machines; and a backend storage system of a second type in which data volumes are stored on storage devices virtually associated with respective machines, the method comprising:
providing configuration data which defines for each data volume at least one primary mount, wherein a primary mount is a machine with which the data volume is associated;
generating a command to a volume manager connected to access the configuration data, wherein the command defines an operation on the data volume which is agnostic and does not vary with the backend storage system type in which the data volume to be acted on is stored;
implementing the command in a convergence agent based on the configuration data for the data volume, wherein the convergence agent acts on the command to execute the operation in its backend storage system based on the configuration data.

7. A method according to claim 6, wherein the volume manager issues a command instruction to the convergence agent to implement the command, and issues at least one subsequent poll instruction to request implementation status from the convergence agent.

8. A method according to claim 7, wherein the convergence agent sets a mobility flag in the configuration data indicating the movement status of a data volume.

9. A method according to claim 6, wherein the volume manager sets a lease required status on the primary mount when a data volume has been mounted thereon, and sets a lease released state when a data volume has commenced movement from the primary mount.

10. A server hosting an application associated with a data set, the server comprises:
an interface for communicating with a client for delivering the application to the client;
a storage interface configured to access a backend storage system in which data volumes of the data set are stored on storage devices;
the server having access to a configuration data store including configuration data which defines for each data volume the server as a primary mount for the data volume;
the server comprising a volume manager connected to access the configuration data store and having a command interface configured to receive commands to act on a data volume; and
a convergence agent associated with the backend storage system and operable to implement a command instruction received from the volume manager by executing steps to control its backend storage system, wherein the volume manager is configured to receive a command which defines an operation on the data volume which is agnostic of, and does not vary with, the backend storage system type in which the data volume to be acted on is stored, and to direct a command instruction to the convergence agent based on the configuration data for the data volume, when the configuration agent is operable to act on the command instructions to execute the operation and the data volume in its backend storage system.

11. A server according to claim 10 wherein the application delivers a service to the client.

12. A server according to claim 10 wherein the application supports a database for the client.

13. A cluster of servers, wherein each server is in accordance with claim 10, and wherein the backend storage system of the servers in the cluster are of the same type, and wherein the volume manager is accessible by the server in the cluster to issue commands to the volume manager.

14. A method of changing a backend storage system associated with a server, the method comprising:
providing a server with a backend storage system of a first type in which data volumes are stored on storage devices physically associated with the server;
removing the backend storage system of the first type and replacing it with a backend storage system of a second type in which data volumes are stored on storage devices virtually associated with the server, each server being configured to access a controller with a configuration data store which includes configuration data which defines for each data volume the server as the primary mount, wherein a volume manager of the server accesses the configuration data store and receives the command to act on the data volume, and wherein a convergence agent implements the command received from the volume manager by executing steps to control its backend storage system, when the volume manager is configured to receive a command which defines a operation on the data volume which is a diagnostic of, and does not vary with, the backend storage system type in which the data volume to be acted on is stored, and to direct the command instruction to the convergence agents based on the configuration data for the data volume, wherein the convergence agent is operable to act on the command instructions to execute the operation in the backend storage system of the second type.

15. A data storage controller according to claim 1 when used in a storage environment comprising a backend storage system of the first type, which is a peer to peer storage system.

16. A data storage controller according to claim 1, when used in a storage environment comprising a backend storage system as a second type which is a network file system.

17. A data storage controller according to claim 1, when used in a storage environment comprising a backend storage system of a second type which is a network block device.
